(19) United States
(12) Patent Application Publication
(10) Pub. No.: US 2007/0254084 A1
(43) Pub. Date: Nov. 1, 2007

(54) Machine for producing and dispensing ice cream

(76) Inventors: Gino Cocchi, Bologna (IT); Gianni Zaniboni, Borgonuovo Di Sasso Marconi (IT)

Correspondence Address: Harbin King & Klima, 500 Ninth Street SE, Washington, DC, 20003, US

(21) Appl. No.: 11/785,843

(22) Filed: Apr. 20, 2007

(30) Foreign Application Priority Data
Apr. 28, 2006 (IT) BO2006A000318

(51) Int. Cl. A23G 9/00

(52) U.S. Cl. 426/565

(57) ABSTRACT

A machine for producing and dispensing ice cream, in particular ice cream frappes or shakes comprises a shake production unit connected to a product dispensing device and sensor means for measuring the quantity of shake dispensed; the sensor means comprise at least one emitter of at least one laser ray passing through a container for collecting the shake dispensed having at least one window transparent to the laser ray; the latter is interrupted by the shake present in the container when it reaches a predetermined level, interrupting shake dispensing.

### BACKGROUND OF THE INVENTION

The present invention relates to a machine for producing and dispensing ice cream.

In particular, the present invention relates to a machine for dispensing “ice cream frappes” or “shakes”, without limiting the scope of the invention.

The term “ice cream frappe” or “shake” is used here to refer to any frozen or semi-frozen foodstuff with a neutral flavor, which may be whipped with a syrup which has the desired flavor, having a semi-liquid consistency, that is to say a consistency such that it takes on the shape of the container which contains the foodstuff.

Prior art machines of the type described above comprise an ice cream production section which may be connected to a mixing unit for introducing and mixing the syrups.

The production section is connected to a dispensing device to allow a user to obtain a quantity of ready to eat ice cream.

The dispensing devices may be operated manually or, more appropriately, they can be controlled by a control and command unit managed by one or more sensors for detecting the quantity of ice cream dispensed, so as to guarantee that the container placed below the dispensing device and intended to receive the ice cream is filled correctly.

As is known, said sensors consist of devices designed to detect the weight of the ice cream dispensed, for example load cells.

In this case, the density of the ice cream must be controlled continuously and precisely during its production, to avoid possible variations, for example with variations in the type of mixture, which would consequently prevent the container from being filled correctly.

Even small variations in the density may lead to unacceptable variations in the volume of product dispensed.

In other cases there are volumetric sensors able to control the quantity of ice cream dispensed.

However, as is known, volumetric sensors are very complex, expensive and difficult to wash both manually and automatically.

### SUMMARY OF THE INVENTION

The aim of the present invention is therefore to overcome the above-mentioned disadvantages by providing a machine for producing and dispensing ice cream, and more precisely ice cream frappes or shakes, which is free of the disadvantages described above.

Accordingly, the present invention achieves this aim with a machine for producing and dispensing ice cream, in particular ice cream frappes or shakes, which has the features described in one or more of the claims herein.

### BRIEF DESCRIPTION OF THE DRAWINGS

The technical features of the invention, in accordance with the afore-mentioned aims, are clearly indicated in the claims herein and the advantages of the invention are more apparent in the detailed description which follows, with reference to the accompanying drawings, which illustrate a preferred embodiment without limiting the scope of the invention, in which:

FIG. 1 is a schematic perspective view of a machine for producing and dispensing ice cream, in particular ice cream frappes or shakes, in accordance with the present invention;

FIGS. 2 and 3 illustrate an enlarged detail of the machine from FIG. 1 in two different operating conditions;

FIG. 4 illustrates another embodiment of the detail from FIG. 2;

FIG. 5 illustrates the detail from FIGS. 2 and 3 in a different configuration; and

FIG. 6 is a schematic block diagram of the machine of FIG. 1.

### DESCRIPTION OF THE PREFERRED EMBODIMENTS

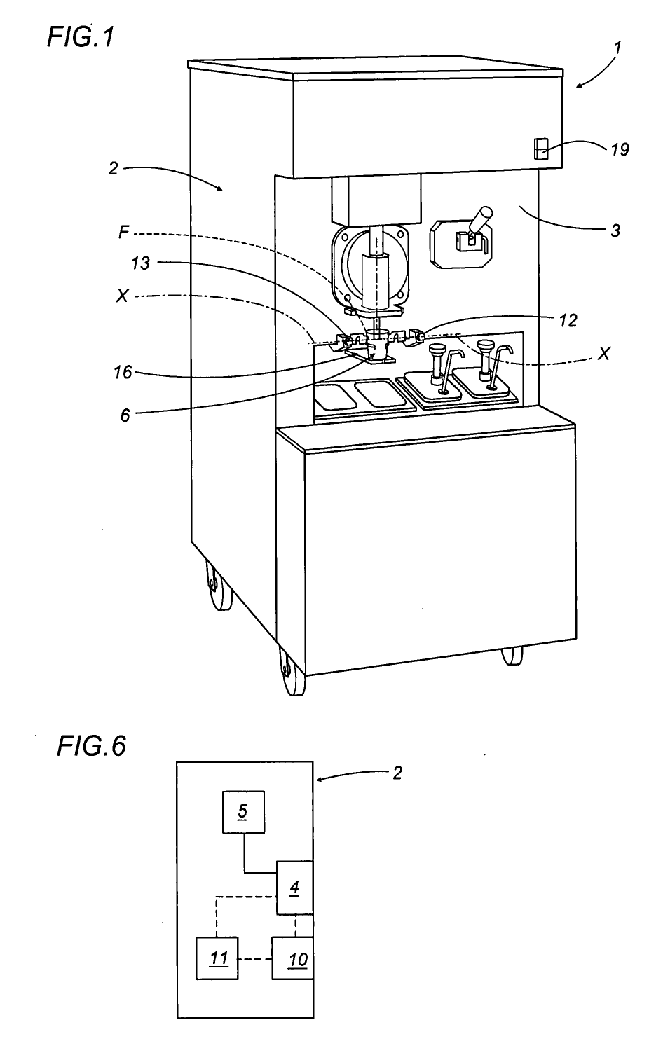

With reference to FIG. 1, the numeral 1 denotes as a whole a machine for producing and dispensing ice cream frappes or shakes.

The machine 1 comprises a box-shaped base 2, substantially having the shape of a parallelepiped, delimited by a vertical front wall 3, where there is a device 4 for dispensing predetermined doses of shakes.

As is schematically illustrated in FIG. 6, inside the base 2 there is a known type of unit 5 for producing ice cream, in particular shakes.

The ice cream production unit 5 is connected, in the known way, to the dispensing device 4 to allow dispensing of the shake produced into a collection container 6.

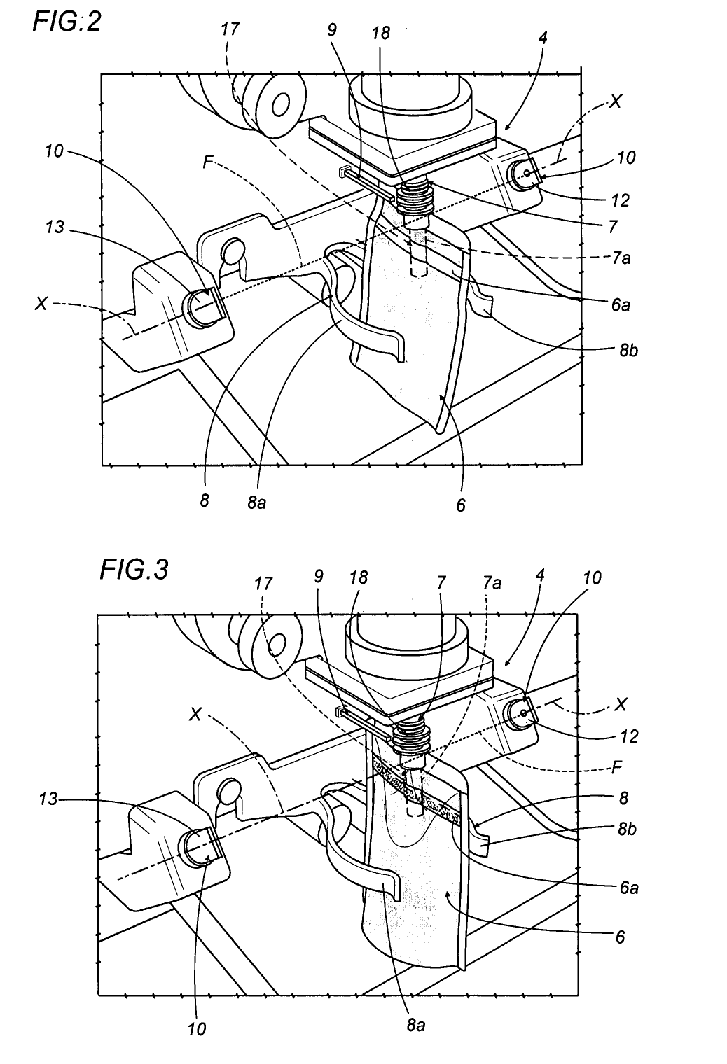

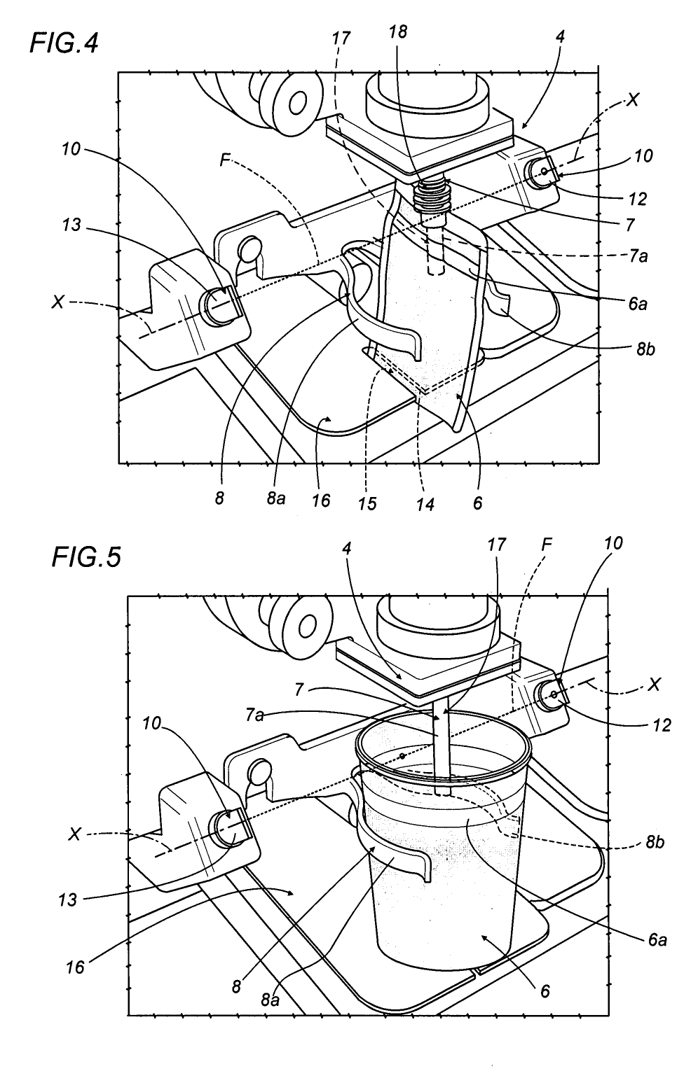

For this purpose, as illustrated in FIGS. 2, 3, 4 and 5, the dispensing device 4 comprises a dispensing nozzle 7 positioned close to collection container 6 positioning and holding means 8.

The dispensing nozzle 7 consists of a hollow cylindrical body 7a, through which the shake flows, extending for a length such that during the container 6 filling step it is able to guarantee that the shake is directed towards the bottom of the container 6 and does not tend to come out.

In the preferred embodiment illustrated in the accompanying drawings, the positioning and holding means 8 comprise two elastically deformable arms 8a and 8b extending substantially in a semi-circle which can hold a container 6 having the shape of a cup or the like (see FIG. 5).

The positioning and holding means 8 are vertically aligned and positioned below the dispensing nozzle 7, in such a way that the container 6 can be placed in the correct position to directly receive the shake dispensed by the dispensing device 4.

Advantageously, as illustrated in FIGS. 2, 3, 4 and 5, the machine 1 also comprises sensor means 10 able to detect the quantity of shake dispensed into the container 6 and to automatically stop shake dispensing.

For this purpose, as is schematically illustrated in FIG. 6, inside the box-shaped base 2 there are dispensing device 4 control and command means 11, operatively connected, in the known way and therefore not described in further detail, to the sensor means 10 and to the dispensing nozzle 7 to activate or stop shake dispensing.

Advantageously, the sensor means 10 comprise at least one emitter 12 of at least one energy ray F of the electromagnetic or laser type able to pass through the container 6 used to collect the shake dispensed, to intercept the shake contained in the container 6 (as illustrated in FIG. 2 relative to a container 6 of the soft type and as illustrated in FIG. 5 relative to a container 6 of the cup type).

The sensor means 10 also comprise a receiver 13 for the ray F emitted by the emitter 12, for receiving the ray emitted and for emitting a command signal to the dispensing device 4 control and command means 11.

The receiver 13 is positioned on the opposite side of the container 6 holding means 8 to the emitter 12, so that the ray F passes through the container 6 and intercepts the shake contained in it.

In particular, the emitter 12 and the receiver 13 are aligned with one another along an axis X which is substantially horizontal and coincides with the direction of propagation of the ray F.

In this way, the ray F is parallel with the free surface of the shake contained in the container 6, allowing the level of the shake present in the container 6 to be identified.

In the preferred embodiment, the ray F emitted by the emitter 12 belonging to the sensor means 10 is a laser ray, preferably with low energy content so that it does not alter the properties of the shake which it intercepts.

However, it should be noticed that the ray F may also be obtained with a beam of electromagnetic waves of any type and belonging to the range of electromagnetic waves which are invisible or visible, for example infrared and ultraviolet.

Moreover, even in the laser rays range the most suitable rays may be used, exploiting the various types of operation of lasers which may be summarized according to the following three processes: by spontaneous emission, by stimulated emission or by absorption, arriving at electron lasers which emit beams of waves typically electromagnetic.

It should be noticed that the ray F, in particular, as indicated, the laser ray F, cannot pass through the shake.

In other words, the shake is impermeable to the ray F emitted.

In contrast, the ray F emitted by the sensor means 10 finds the container 6 permeable, therefore the ray can pass through the container.

A type of container 6 suitable for this purpose consists, for example, of plastic transparent for the wavelength of the type of laser emitter used.

Therefore, if the laser used emits a ray whose wavelength is within the visible range, the container 6 comprises at least one region 6a through which the light ray can pass.

It should be emphasized that the container 6 must be transparent to the laser ray F only in the region 6a actually affected by the ray, therefore making any other zone available to carry advertising messages, as is schematically illustrated in FIGS. 2, 3, 4 and 5. In the preferred embodiment, said region 6a of the container 6 consists of a window having a predetermined height, extending along the entire periphery of the container 6.

To allow use of containers 6 of the soft type having a substantially flat rectangular shape (as illustrated in FIGS. 2, 3 and 4), the positioning and holding means 8 consist of a rod 9 fixed to the wall 3 and pointing, perpendicularly to the wall 3, towards the nozzle 7. In this way, the user is forced to position the soft container 6 in the correct way, that is to say, in a position in which it lies in a plane substantially perpendicular to the wall 3.

In another embodiment the positioning and holding means 8 consist of a guide 14, preferably a groove 15, in which the lower portion of the container 6 must be inserted to guarantee correct alignment of the container with the laser ray F.

The guide 14 is made on a collection plate 16 positioned below the elastically deformable arms 8a and 8b and aligned with the dispensing nozzle 7.

The collection plate 16 is also designed to collect and hold any shake residues which may accidentally come out of the dispensing nozzle 7.

Moreover, the latter comprises means 17 for rapid engagement of the container 6 closing cap 18 on the dispensing device.

In the preferred embodiment, the engagement means 17 coincide with the hollow cylindrical body 7a which constitutes the dispensing nozzle 7, as illustrated in FIGS. 2, 3, 4 and 5.

In practice, any form of container 6, for example of the soft type illustrated in FIG. 2 or the cup type illustrated in FIG. 5, is placed below the dispensing nozzle 7. Correct positioning of a soft container is guaranteed by the rod 9, whilst a cup type container is positioned and held by the two arms 8a and 8b.

The shake is dispensed, for example by pressing an activation button 19 and the container 6 begins to fill up.

The sensor means 10, and in particular their laser ray F, is activated by the control and command means 11 and passes through the container 6, then is intercepted by the receiver 13.

When the quantity of shake reaches the predetermined level in the container 6, the laser ray F intercepts the shake and does not reach the receiver 13, as illustrated in FIG. 3.

At this point, the control and command means 11 receive a command from the receiver 13 which in turn emits a command signal and they interrupt shake dispensing, guaranteeing the desired container 6 filling.

It should be noticed that the machine 1 according to the present invention eliminates the disadvantages encountered in the prior art.

Optimum filling is guaranteed irrespective of the density or the type of shake dispensed. Moreover, the laser beam F emitter and receiver guarantee very simple production with low costs. Finally, both the emitter and the receiver of the laser beam can easily be cleaned and sanitized, contributing to greater machine cleanliness.

The invention described above is susceptible of industrial application and may be modified and adapted in several ways without thereby departing from the scope of the inventive concept. Moreover, all details of the invention may be substituted by technically equivalent elements.

1. A machine for producing and dispensing ice cream, in particular ice cream frappes or shakes comprising a shake production unit connected to a dispensing device for the shake produced and sensor means for measuring the quantity of shake dispensed; wherein the sensor means comprise at least one emitter of a ray of energy passing through a container for collecting the shake dispensed, to intercept the shake contained in the collection container.

2. The machine according to claim 1, wherein the sensor means also comprise at least one receiver for rays of energy to intercept the ray emitted.

3. The machine according to claim 2, wherein the dispensing device comprises a dispensing nozzle and means for positioning and holding the container below the dispensing nozzle.

4. The machine according to claim 3, wherein the emitter and the receiver for the ray of energy are positioned on opposite sides of the container positioning and holding means.

5. The machine according to claim 4, wherein the shake dispensed is impermeable to the ray of energy emitted by the emitter to interrupt reception by the receiver when a predetermined quantity of shake in the container is reached.

6. The machine according to claim 1, wherein the collection container comprises at least one window through which the ray of energy emitted by the emitter can pass.

7. The machine according to claim 1, wherein the ray of energy is a beam of electromagnetic waves emitted by the emitter.

8. The machine according to claim 1, wherein the ray of energy is a laser ray emitted by the emitter.

9. The machine according to claim 2, wherein the emitter and the receiver are aligned along a substantially horizontal axis.

10. The machine according to claim 8, wherein the beam of electromagnetic rays or the laser ray emitted propagate along the substantially horizontal axis to measure the level of shake present in the collection container.

11. The machine according to claim 3, wherein the dispensing nozzle comprises rapid engagement means for hooking soft collection containers equipped with a closing cap.

12. The machine according to claim 1, comprising dispensing device control and command means operatively connected to the sensor means to activate or inhibit shake dispensing.

13. The machine according to claim 3, wherein the positioning and holding means comprise a guide for the container to angle the container relative to the ray of energy.

14. The machine according to claim 3, wherein the positioning and holding means comprise a rod fixed to the wall and extending substantially perpendicularly towards the dispensing nozzle.
